(19) United States
(12) Patent Application Publication
(10) Pub. No.: US 2016/0088390 A1
(43) Pub. Date: Mar. 24, 2016

(54) AUDIO SIGNAL OUTPUT APPARATUS FOR VEHICLE

(71) Applicant: Hyundai Mobis Co., Ltd., Seoul (KR)

(72) Inventor: Jung Woo HAN, Yongin-si (KR)

(21) Appl. No.: 14/742,177

(22) Filed: Jun. 17, 2015

(30) Foreign Application Priority Data
Sep. 19, 2014 (KR) 10-2014-0124979

(51) Int. Cl. H04R 3/00

(52) U.S. Cl. CPC H04R 3/00; H04R 2420/01; H04R 2499/13; H04R 2420/09

(57) ABSTRACT

An audio signal output apparatus for a vehicle including: a serial data communication unit serially connecting input modules of an audio system within the vehicle, and serially transmitting and receiving an audio signal between the respective input modules; and an amplification module processing the audio signal inputted from the serial data communication unit, and outputting the processed audio signals through a speaker.

### CROSS-REFERENCES TO RELATED APPLICATION

This application claims priority from and the benefit of Korean Patent Application No. 10-2014-0124979, filed on Sep. 19, 2014, which is hereby incorporated by reference for all purposes as if fully set forth herein.

### BACKGROUND

1. Field

Exemplary embodiments relate to an audio signal output apparatus for a vehicle. More particularly, exemplary embodiments relate to an audio signal output apparatus for a vehicle, which is capable of transmitting and receiving audio signals of various input modules, which are connected through a serial bus in a vehicle, through the serial bus.

2. Discussion of the Background

Recently, an audio system in a vehicle has been divided into an integrated control module (head unit) that integrally controls various input modules, and an amplification module that processes and amplifies an audio signal inputted from the integrated control module and outputs the audio signal through a speaker. The input modules may include a USB (Universal Serial Bus) audio input, an analog audio input (AUX), a broadcasting receiver, a CD/DVD input, a mike input for hands-free operation, and the like.

The input modules input audio signals to the integrated control module through various interfaces, such as an analog interface, USB 2.0, I2S (Inter-IC Sound), MOST (Media Oriented Systems Transport), and Ethernet, according to the system configuration and the characteristics of the respective audio signals. The integrated control module transmits currently played sound signals in parallel to the amplifier module, processes the sound signals through a DSP (Digital Signal Processor), amplifies the processed signals, and outputs the amplified signals through the speaker.

However, the above-described audio system employs various types of transmission schemes such that various input modules can transmit signals. Thus, the length of cables is inevitably increased, and the type and number of cables are also increased. Therefore, various kinds of electromagnetic noise may be introduced into the system.

In order to solve such a problem, the MOST system has been adopted, which forms a signal chain of the respective modules in a ring shape, and receives signals in parallel using an optical cable. However, because the price of the cable is high, the MOST system cannot still solve the problem caused by the length of the cable. Recently, a method using Ethernet has been developed. However, the problem of the parallel transmission scheme, such as a cable length or electromagnetic noise, still remains. Furthermore, an excessive cost must be put to construct a physical layer.

The related art of the present invention is disclosed in Korean Patent Laid-open Publication No. 10-2007-0038831, published on Apr. 11, 2007.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide an audio signal output apparatus for a vehicle, which transmits and receives audio signals of various input modules, which are connected through a serial bus in a vehicle, through the serial bus.

Exemplary embodiments also provide an audio signal output apparatus for a vehicle, which serially connects a plurality of input modules so as to reduce the length of a cable, and replaces a shield cable used in a mike with a twist pair cable suitable for serial communication, thereby reducing the production cost of a vehicle audio system.

Exemplary embodiments also provide an audio signal output apparatus for a vehicle, which serially connects a plurality of input modules to an amplification module so as to reduce a delay time caused by an integrated control module, and dualizes the front and rear seats of the vehicle such that a plurality of audio signals can be played at the same time.

Additional aspects will be set forth in the detailed description which follows, and, in part, will be apparent from the disclosure, or may be learned by practice of the inventive concept.

An exemplary embodiment discloses an audio signal output apparatus for a vehicle, including: a serial data communication unit serially connecting input modules of an audio system within the vehicle, and configured to serially transmit and receive an audio signal between the respective input modules; and an amplification module configured to process the audio signal inputted from the serial data communication unit, and output the processed audio signals through a speaker.

An exemplary embodiment also discloses an audio signal output apparatus for a vehicle including: one or more serial transceivers having identification information set therein, installed to correspond one-to-one to one or more input modules, connected in series to each other so as to serially transmit and receive audio signals of the input modules, and configured to add the identification information to the audio signals of the corresponding input modules so as to transmit and receive the audio signals; and an audio signal adjuster configured to receive an audio signal from any one of the serial transceivers, adjust an output time of the audio signal according to the identification information, and input the audio signal to an amplification module.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a diagram illustrating a serial bus configuration of an audio signal output apparatus for a vehicle in accordance with an exemplary embodiment of the present invention.

FIG. 2 is a block configuration diagram of the audio signal output apparatus for a vehicle in accordance with an exemplary embodiment of the present invention.

FIG. 3 is a diagram illustrating an example in which a delay time adjuster in accordance with an exemplary embodiment of the present invention adjusts a delay time.

FIG. 4 is a diagram conceptually illustrating an example in which an input module of the audio signal output apparatus for a vehicle in accordance with an exemplary embodiment of the present invention is added.

### BRIEF DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of elements may be exaggerated for clarity and descriptive purposes. Also, like reference numerals denote like elements.

When an element is referred to as being “on,” “connected to,” or “coupled to” another element, it may be directly on, connected to, or coupled to the other element or intervening elements or layers may be present. When, however, an element is referred to as being “directly on,” “directly connected to,” or “directly coupled to” another element, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, and/or sections, these elements, components, regions, layers, and/or sections should not be limited by these terms. These terms are used to distinguish one element, component, region, and/or section from another element, component, region, layer, and/or section. Thus, a first element, component, region, and/or section discussed below could be termed a second element, component, region, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

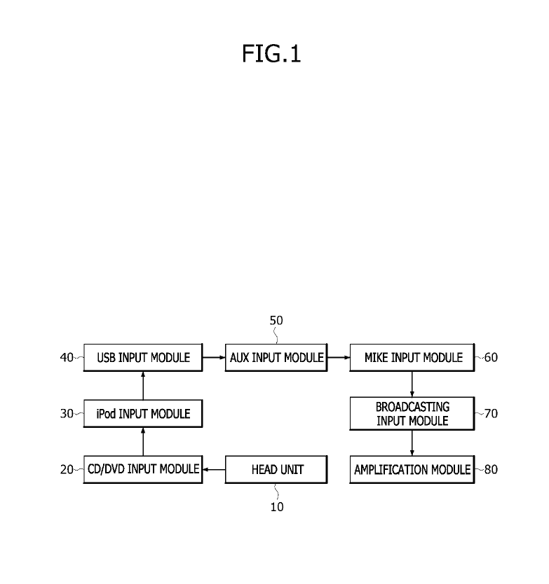

Referring to FIG. 1, the audio signal output apparatus for a vehicle in accordance with an exemplary embodiment of the present invention may serially connect various input modules of a vehicle audio system, for example, a CD (Compact Disc)/DVD (Digital Versatile Disc) input module 20, an iPod input module 30, a USB (Universal Serial Bus) input module 40, an AUX (Auxiliary) input module 50, a mike input module 60, and a broadcasting input module 70.

The head unit 10 may integrally control the above-described input modules. The head unit 10 may be additionally connected to another input module besides the above-described input modules, and be considered as one of the input modules. Thus, the head unit 10 may be connected in series to the CD/DVD input module 20 or the like.

For reference, the input module of the vehicle audio system is not limited to the above-described embodiment. Furthermore, various input modules may be adopted as the input modules, as long as the input modules can be provided in the vehicle so as to output audio signals.

When the input modules of the vehicle audio system are connected through the above-described serial bus system, only a minimum amount of cable need be used in consideration of a distance between the various input modules provided in the vehicle. Thus, the length of the cable used in the vehicle audio system can be significantly reduced. As a result, the manufacturing cost of the vehicle audio system can be reduced.

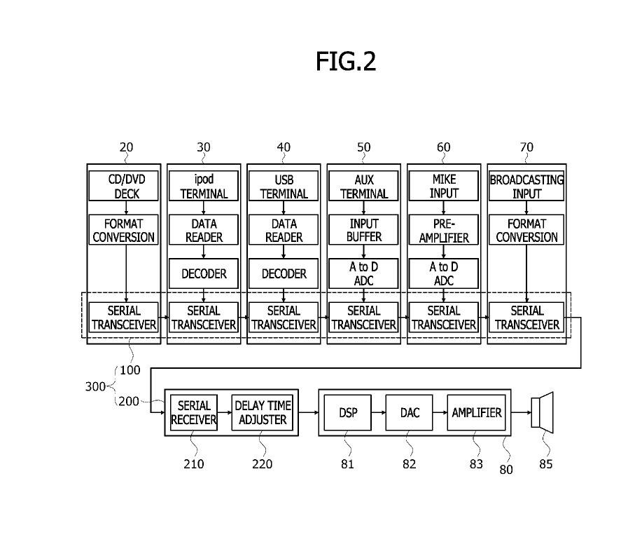

Referring to FIG. 2, the audio signal output apparatus for a vehicle may include a serial data communication unit 300 and an amplification module 80. The serial data communication unit 300 may connect the above-described input modules through the serial bus system, and the amplification module 80 may process an audio signal inputted from the serial data communication unit 300 and output the processed signal to a speaker 85.

The serial data communication unit 300 may include a plurality of serial transceivers 100 and an audio signal adjuster 200.

The plurality of serial transceivers 100 may be installed to correspond one-to-one to the respective input modules. The serial transceivers 100 may be connected in series to each other and transmit the audio signals of the respective input modules to the amplification module 80.

For reference, FIG. 2 illustrates that the serial transceivers 100 are installed in the respective input modules. However, the serial transceivers 100 are not necessarily installed in the respective input modules, but may be installed outside the respective input modules, as necessary. That is, as long as a serial transceiver 100 can transmit an audio signal of the corresponding input module to another serial transceiver 100 connected in series to the serial transceiver 100, the installation position of the serial transceiver 100 is not limited, but the serial transceiver 100 may be installed inside or outside the input module.

Each of the serial transceivers 100 may have identification information set therein. The identification information may be used to identify each of the input modules.

Each of the serial transceivers 100 may transmit an audio signal of the corresponding input module on a frame basis. At this time, the serial transceiver 100 may form an ID sub frame by adding the identification information to any one of the frames, and transmit the ID sub frame.

The ID sub frame may include the identification information as well as the audio signal. The audio signal adjuster 200 may recognize the input module having transmitted the audio signal, based on the corresponding identification information, determine a delay time at which the audio signal is to be outputted, and transmit the determined delay time to the amplification module 80. The delay time will be described below.

For example, when an audio signal of the CD/DVD input module 20 is outputted, the serial transceiver 100 corresponding to the CD/DVD input module 20 may transmit the audio signal on a frame basis. At this time, the serial transceiver 100 may generate an ID sub frame by adding identification information, which is preset to the CD/DVD input module 20, to any one of the frames.

Then, the audio signal of the CD/DVD input module 20 may be transmitted to the audio signal adjuster 200 through the respective serial transceivers 100 of the iPod input module 30, the USB input module 40, the AUX input module 50, the mike input module 60, and the broadcasting input module 70, which are connected in series.

For reference, each of the CD/DVD input module 20, the iPod input module 30, the USB input module 40, the AUX input module 50, the mike input module 60, and the broadcasting input module 70 in FIG. 2 may perform its own processing on the corresponding audio signal. Because the processing is performed in the same manner as the existing processing, the detailed descriptions thereof are omitted herein.

The audio signal adjuster 200 may receive an audio signal from any one of the serial transceivers 100, that is, the input module connected in series to the audio signal adjuster 200, detect the identification information from the ID sub frame added to the received audio signal, adjust an output time of the audio signal based on the detected identification information, and input the audio signal to the amplification module 80.

The audio signal adjuster 200 may include a serial receiver 210 and a delay time adjuster 220.

The serial receiver 210 may be connected in series to any one of the above-described input modules, receive an audio signal from the input module connected in series to the serial receiver 210, and input the audio signal to the delay time adjuster 220.

The delay time adjuster 220 may adjust the time at which the audio signal inputted from the serial receiver 210 is to be outputted to the amplification module 80, based on the identification information set to each of the input modules.

When the audio signal is transmitted through a serial transmission method, a delay of one frame may occur while the audio signal passes through each of the input modules. The delay time adjuster 220 may remove the delay that occurs while the audio signal is transmitted as described above.

As described above, when each of the serial transceivers 100 transmits an audio signal of the corresponding input module, the serial transceiver 100 may form an ID sub frame obtained by adding identification information to any one of the frames, and then transmit the ID sub frame.

The delay time adjuster 220 may detect the identification information of the ID sub frame within the audio signal, delay the output of the audio signal by a time set for the identification information, and remove a delay time error between the respective input modules. The time may be set in such a manner that total delay times required until audio signals of the respective input modules are inputted to the amplification module 80 are equal to each other.

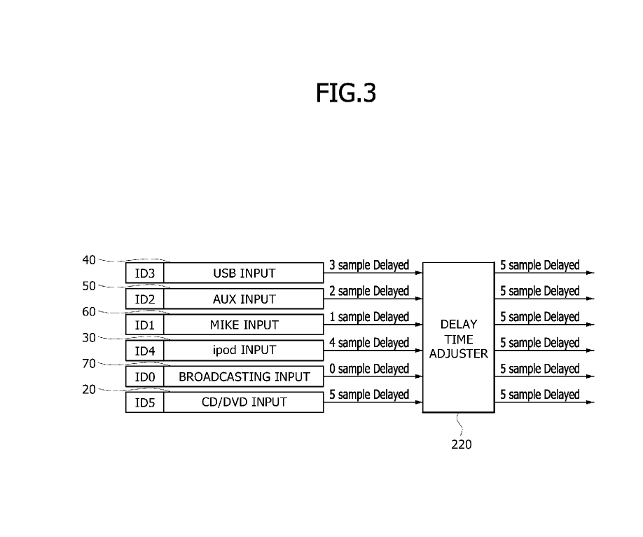

As illustrated in FIG. 3, the USB input module 40 may have identification information set to ‘3’, and an audio signal may be delayed by 3 samples through the USB input module 40. The AUX input module 50 may have identification information set to ‘2’, and an audio signal may be delayed by 2 samples through the AUX input module 50. The mike input module 60 may have identification information set to ‘1’, and an audio signal may be delayed by 1 sample through the mike input module 60. The iPod input module 30 may have identification information set to ‘4’, and an audio signal may be delayed by 4 samples through the iPod input module 30. The broadcasting input module 70 may have identification information set to ‘0’, and an audio signal may be delayed by 0 samples through the broadcasting input module 70. The CD/DVD input module 20 may have identification information set to ‘5’, and an audio signal may be delayed by 5 samples through the CD/DVD input module 20.

In this case, the delay time adjuster 220 may additionally delay the audio signal transmitted from the USB input module 40 by 2 samples set in the identification information ‘3’ of the USB input module 40 such that the audio signal is delayed by 5 samples, and additionally delay the audio signal transmitted from the AUX input module 50 by 3 samples set in the identification information ‘2’ of the AUX input module 50 such that the audio signal is delayed by 5 samples. Furthermore, the delay time adjuster 220 may additionally delay the audio signal transmitted from the mike input module 60 by 4 samples set in the identification information ‘1’ of the mike input module 60 such that the audio signal is delayed by 5 samples, additionally delay the audio signal transmitted from the iPod input module 30 by 1 sample set in the identification information ‘4’ of the iPod input module 30 such that the audio signal is delayed by 5 samples, additionally delay the audio signal transmitted from the broadcasting input module 70 by 5 samples set in the identification information ‘0’ of the broadcasting input module 70 such that the audio signal is delayed by 5 samples, and additionally delay the audio signal transmitted from the CD/DVD input module 20 by 0 samples set in the identification information ‘5’ of the CD/DVD input module 20 such that the audio signal is delayed by 5 samples.

That is, the delay time adjuster 220 may delay the outputs of the audio signals transmitted from the input modules by the times set in the respective pieces of identification information of the ID sub frames within the audio signals, thereby equalizing the delay times required until the audio signals outputted from the respective input modules are inputted to the amplification module 80.

In the above-described exemplary embodiment, the audio signals transmitted from the respective input modules may have a delay time of 5 samples, and a delay of 0.104 ms may occur when the vehicle audio system utilizes a sampling rate of 48 kHz. However, the above-described delay may be considered as a level which can be ignored during echo canceling for call sound or image/voice matching for DVD or DMB.

Furthermore, since the respective input modules are connected in series to input audio signals to the amplification module 80, a delay time caused by the head unit 10 can be reduced, and various audio signals can be received at the same time. Thus, the front and rear seats can be dualized, or a plurality of audio signals can be played at the same time.

The amplification module 80 may output an audio signal inputted from the audio signal adjuster 200 through the speaker 85.

The amplification module 80 may include a DSP (Digital Signal Processor) 81, a DAC (Digital Analog Converter) 82, and an amplifier 83.

The DSP 81 may process the audio signal inputted from the audio signal adjuster 200. For example, the DSP 81 may perform signal processing, such as volume control, tone control, and equalizer function control, on the audio signal.

The DAC 82 may convert the audio signal inputted from the DSP 81 into an analog signal and input the analog signal to the amplifier 83.

The amplifier 83 may amplify the audio signal converted into the analog signal by the DAC 82, and output the amplified signal through the speaker 85.

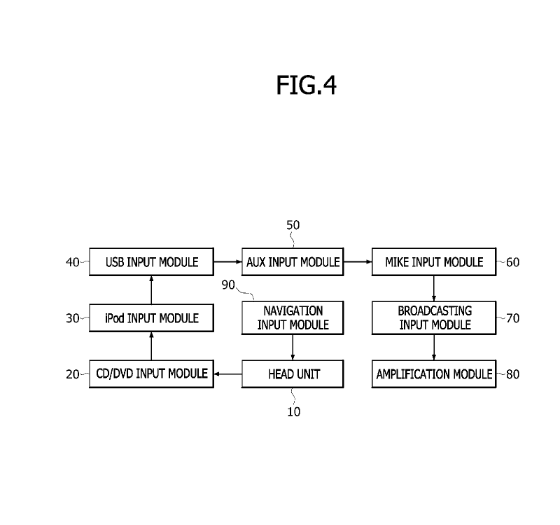

Because the audio signal output apparatus for a vehicle in accordance with an exemplary embodiment of the present invention includes the plurality of input modules connected in series as described above, another input module may be added to the installed input modules. That is, as illustrated in FIG. 4, a separate module, such as a navigation input module 90, may be connected to the head unit 10. Thus, the audio signal output apparatus for a vehicle in accordance with an exemplary embodiment of the present invention may have more excellent expandability than existing vehicle audio systems.

In the present exemplary embodiment, the plurality of input modules can be connected in series so as to reduce the length of the cable for transmitting and receiving an audio signal, and a shield cable used in the mike or the like can be replaced with a twist pair cable suitable for serial communication, which makes it possible to reduce the production cost of the vehicle audio system.

Furthermore, the plurality of input modules can be connected in series to the amplification module so as to reduce a delay time caused by the integrated control module, and the front and rear seats of the vehicle can be dualized to play a plurality of audio signals at the same time.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An audio signal output apparatus for a vehicle, comprising:
one or more serial transceivers having identification information set therein, installed in a one-to-one correspondence with one or more input modules, connected in series to each other so as to serially transmit and receive audio signals of the input modules, and configured to add the identification information to the audio signals of the corresponding input modules so as to transmit and receive the audio signals; and
an audio signal adjuster configured to receive an audio signal from any one of the serial transceivers, adjust an output time of the audio signal according to the identification information, and input the audio signal to an amplification module.

2. The audio signal output apparatus of claim 1, wherein the serial transceiver is configured to transmit the audio signal of the input module on a frame basis, and generate an ID sub frame by adding the identification information to any one of frames.

3. The audio signal output apparatus of claim 2, wherein the audio signal adjuster comprises:
a serial transceiver connected in series to any one of the serial transceivers and configured to receive an audio signal from the serial transceiver connected in series; and
a delay time adjuster configured to detect the ID sub frame from the audio signal inputted from the serial receiver, and adjust an output time of the audio signal to the amplification module based on the identification information added to the ID sub frame.

4. The audio signal output apparatus of claim 3, wherein the delay time adjuster is configured to delay the audio signal inputted from the serial receiver by a time set for the identification information, and output the delayed audio signal to the amplification module.

5. The audio signal output apparatus of claim 4, wherein the time is set in such a manner that total delay times required until the audio signals of the respective input modules are inputted to the amplification module are equal to each other.

6. An audio signal output apparatus for a vehicle, comprising:
a serial data communication unit serially connecting input modules of an audio system within the vehicle, and configured to serially transmit and receive an audio signal between the respective input modules; and
an amplification module configured to process the audio signal inputted from the serial data communication unit, and output the processed audio signals through a speaker.

7. The audio signal output apparatus of claim 6, wherein the serial data communication unit comprises:
one or more serial transceivers installed in a one-to-one correspondence with the input modules so as to be connected in series to each other, and configured to serially transmit and receive audio signals of the input modules; and
an audio signal adjuster configured to receive an audio signal from the serial transceivers, adjust an output time of the received audio signal, and input the adjusted audio signal to the amplification module.

8. The audio signal output apparatus of claim 7, wherein each of the serial transceiver is configured to add preset identification information to the audio signal of the corresponding input module, when transmitting the audio signal.

9. The audio signal output apparatus of claim 8, wherein the serial transceiver is configured to transmit the audio signal of the input module on a frame basis, and generate an ID sub frame by adding the identification information to any one of frames.

10. The audio signal output apparatus of claim 7, wherein the audio signal adjuster comprises:
a serial receiver connected in series to any one of the serial transceivers, and configured to receive an audio signal from the serial transceiver connected in series; and
a delay time adjuster configured to adjust an output time of the audio signal inputted from the serial receiver to the amplification module, based on the identification information set to each of the input modules.

11. The audio signal output apparatus of claim 10, wherein the delay time adjuster is configured to delay the audio signal inputted from the serial receiver by a time set for the identification information, and output the delayed audio signal to the amplification module.

12. The audio signal output apparatus of claim 11, wherein the time is set in such a manner that total delay times required until the audio signals of the respective input modules are inputted to the amplification module are equal to each other.
